(19) United States
(12) Patent Application Publication
(10) Pub. No.: US 2008/0234612 A1
(43) Pub. Date: Sep. 25, 2008

(54) Massage Carriage

(75) Inventor: Dietmar Koch, Lontzen (BE)

Correspondence Address: GROSSMAN, TUCKER, PERREAULT & PFLEGER, PLLC, 55 SOUTH COMMERICAL STREET, MANCHESTER, NH, 03101, US

(73) Assignee: OKIN GESELLSCHAFT FUR ANTRIEBSTECHNIK MBH, Gummersbach (DE)

(21) Appl. No.: 10/598,314

(22) PCT Filed: Feb. 24, 2005
(86) PCT No.: PCT/DE05/00320

§ 371 Date: May 20, 2008

(30) Foreign Application Priority Data
Feb. 25, 2004 (DE) 20 2004 003 066.7

(51) Int. Cl. A61H 7/00

(52) U.S. Cl. 601/100

(57) ABSTRACT

A massage carriage comprises a drive (1) that contains at least one motor and gearing parts, a first shaft (6) that can be moved by the drive (1) and a second shaft (7) that can be moved by the drive (1), two first arms, which are connected to the first shaft (6), can be moved by the first shaft (6) and on each of which a massage element is mounted, and two second arms, which are connected to the second shaft (7) and can be moved by the second shaft (7), one of which each acts on one of the first arms. In order to design the drive to be as compact, particularly as flat, as possible, it displays a single motor (2) with a motor shaft (3), by means of which the first and second shafts (6, 7) can each be moved via a reduction gear (4, 5).

The invention relates to a massage carriage for use in a massage chair or similar that can be moved back and forth along a frame in the massage chair or similar, comprising a drive that contains at least one motor and gearing parts, a first shaft that can be moved by the drive and a second shaft that can be moved by the drive, two first arms, which are connected to the first shaft, can be moved by the first shaft and on each of which a massage element is mounted, and two second arms, which are connected to the second shaft and can be moved by the second shaft, one of which each acts on one of the first arms, such that the massage elements can be moved by the drive with one movement component oriented parallel to the frame and one oriented perpendicular to the frame.

Massage carriages of this kind are known in various designs. In the case of customary use of a massage carriage in the backrest of a massage chair or similar, the two shafts movable by the drive are arranged horizontally and one above the other, e.g. the first shaft above the second shaft. As a rule, the two shafts display eccentric areas at their ends, on which the first or second arms are mounted. In this context, the eccentric area on the ends of the first shaft can be angled relative to this shaft, such that, when the first shaft is rotated, the first arms bearing the massage elements perform a pivoting movement about an essentially horizontal axis that passes through the intersection of the first shaft and the angled axis of the eccentric areas. The massaging action generated by this movement of the massage elements is referred to as “kneading”.

The movement of the second shaft is such that, via its connection by the second arms to the first arms and the movement of the first arms by the first shaft, an essentially vertical movement of the massage elements is generated, possibly with a component oriented perpendicular to the “kneading” movement. The massage action exerted by this movement is also referred to as “tapping”.

To generate the “tapping”, the second shaft can, like the first shaft, be provided with eccentric areas on its ends, to which the second arms are connected in articulated fashion. Like the first shaft, the second shaft is then rotated by the drive. Instead of rotation, however, other forms of movement are also open to consideration, especially for the second shaft, being induced by the drive and enabling the “kneading” and “tapping” movements of the massage elements described above.

A massage carriage of the type mentioned in the opening paragraph is known from WO 97/37627, where the upper, first shaft and the lower, second shaft are driven by an upper and a lower geared motor. The drive comprising two motors, which are spatially assigned to the upper and lower shafts, has a correspondingly large space requirement, such that the back part of a chair or other item of furniture accommodating the massage carriage has to be designed accordingly. Correspondingly large openings have to be provided for installation of a massage carriage with a drive of this kind.

GB1 400 473 A discloses a massage carriage where the upper, first shaft and the lower, second shaft are driven by a shaft arranged perpendicular to them, which is rotated by a single motor via a belt drive. This drive, too, has a relatively large space requirement, meaning that the aforementioned disadvantages likewise apply to a massage carriage known from GB1 400 473 A.

The object of the present invention is to develop a massage carriage of the kind mentioned in the opening paragraph in such a way that the drive is designed to be compact, particularly flat, in which context it can easily be installed in the back part of a massage chair or other item of furniture without elaborate measures.

According to the invention, the object is solved in that, in a massage carriage of the kind mentioned in the opening paragraph, the drive displays a single motor with a motor shaft, by means of which the first and second shafts can each be moved via a reduction gear.

The movement of the shafts can consist in a rotary movement, where eccentric sections are preferably provided on the ends of the shafts for articulated connection of the arms. The second shaft, in particular, can, however, also be moved in two or three dimensions without proper rotation, in order to set the massage elements into “kneading” and “tapping” motion via the first and second arms together with the movement of the first shaft.

Due to the single motor with the two reduction gears mounted on the motor shaft, the drive comprising the motor and the gearing parts can be of relatively compact, particularly flat, design. The massage carriage with the built-in drive thus requires relatively little space in the backrest of a massage chair or other item of furniture equipped with a massage carriage, and can be inserted into the item of furniture through smaller openings, e.g. on the underside of the backrest of a massage chair.

In a preferred embodiment of the invention, the motor shaft can display two shaft sections, located on opposite face ends of the motor and aligned parallel to each other, by means of which the first and second shafts can be moved via the respective reduction gear. An extremely compact drive can be realized as a result of the gearing parts being arranged on both sides of the motor.

In a particularly simple and cost-saving embodiment of the massage carriage according to the invention, the shaft sections can be sections of a continuous motor shaft.

In this context, the reduction gear via which the second shaft can be moved is provided with a free-wheel device in a particular sense of rotation of the motor shaft. In this sense of rotation, the first shaft is driven by the motor, whereas the second shaft does not rotate because of the free-wheel device. The movement transmitted to the massage elements thus corresponds exclusively to the “kneading” movement.

In this embodiment, both the first and the second shaft are driven when the motor shaft is turned in the other sense of rotation by the reversible motor. At the same rpm speed of the motor as when only the first shaft is driven, the “tapping” movement caused by operation of the second arms is superimposed on the “kneading” movement caused by the first arms, such that the massaging action corresponds to “foulage” (=kneading plus tapping). At twice the rpm speed of the motor, or even faster, the “tapping” movement of the massage elements predominates. In this way, selection of the sense of rotation and the rpm speed of the continuous shaft makes it possible to set “kneading” or simultaneous “kneading” and “tapping”, and to simulate “tapping”.

In a more sophisticated embodiment of the invention, one of the shaft sections is permanently driven by the motor, while the other shaft section can be disconnected from the motor by means of a clutch. The two shaft sections are again aligned with their axes parallel to each other. The two shaft sections preferably have the same axis.

In a preferred embodiment, the clutch can be designed as an electromagnetic clutch.

Furthermore, the clutch can display an automatic brake, by means of which the disconnectable shaft section can be braked or blocked in disconnected state. The automatic brake can, for example, display an integrated spring mechanism.

A brake of this kind can be used to prevent uncontrolled rotation of the disconnected shaft section.

The shaft section permanently driven by the motor, and the reduction gear mounted on it, is used to move the second shaft, generally meaning to set it rotating, in which context the second arms are operated by eccentric areas located on the ends of the shaft, these arms setting the massage elements into “tapping” motion via the first arms. The connectable and disconnectable shaft section permits activation and deactivation of a “kneading” movement.

To deactivate the “tapping” movement, the reduction gear that is located on the shaft section permanently driven by the motor, and via which the second shaft can be moved, is provided with a free-wheel device in the other sense of rotation of the motor shaft. This makes it possible with the single motor both to activate the “kneading” and “tapping” functions separately, and also to perform both functions simultaneously.

In an expedient development of the invention, the drive displays a housing comprising two shells for the motor and the gearing parts. In a particularly expedient embodiment of the housing, the bearing arrangement for the motor and the gearing parts is integrated in the housing in one piece, such that the motor and the gearing parts can simply be inserted into the housing.

In particular, the housing shells and the bearing arrangement for the motor and the gearing parts can be made of plastic, injection-molded in one piece.

Due to the technique of inserting the motor and gearing parts into the housing shells, in conjunction with the space-saving motor with integrated clutch, is it possible to realize an extremely compact and flat drive unit. A considerably slimmer design of the chair back can be achieved as a result.

Expediently, one part of the nut needed for driving the spindle in the vertical direction of the frame can be integrally molded on the housing in one piece, in which context the other part of the nut can be fastened on said part from the outside in order to accommodate the spindle between the two parts.

The reduction gears located on the motor shaft, or on the shaft sections with parallel axes leading out of the motor at the face ends, can be designed as worm gears. For this purpose, the ends of the motor shaft or its shaft sections preferably display worm sections that interact with worm wheels, via which the first and second axes can be moved.

Both embodiments of the invention are described in more detail below on the basis of the drawing.

The Figures show the following:

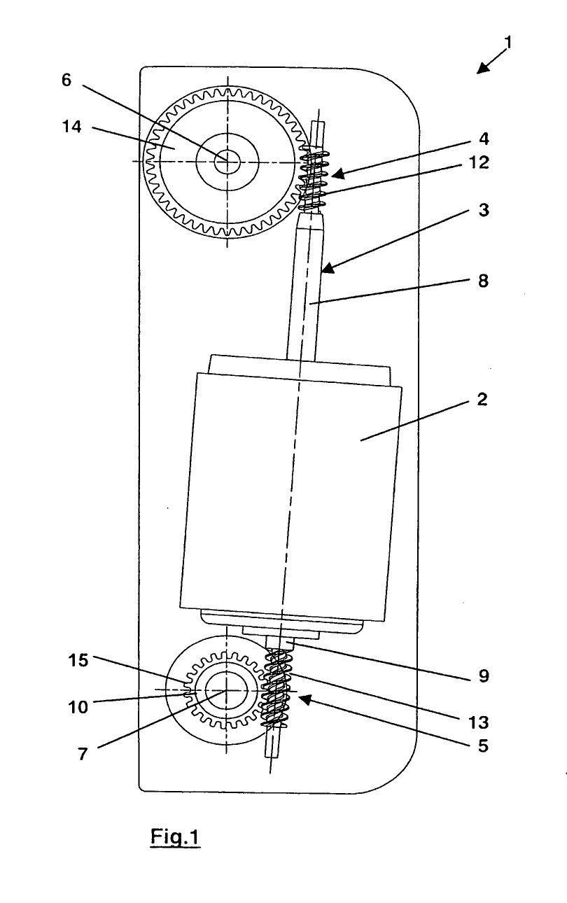

FIG. 1A schematic side view of a drive for a massage carriage, located in a housing, comprising a motor with a continuous motor shaft and gearing parts,

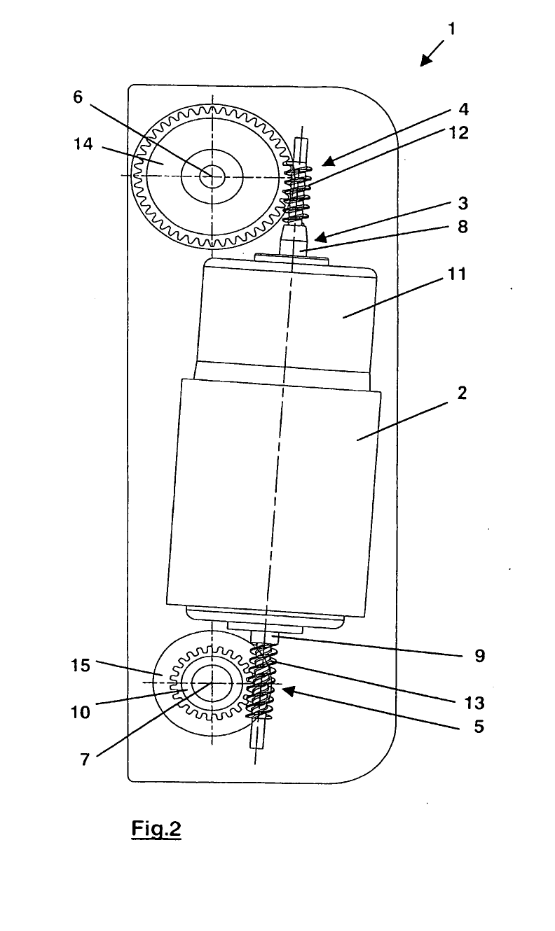

FIG. 2 A schematic side view of a drive, located in a housing, comprising a motor with integrated clutch and shaft sections with gearing parts located thereon,

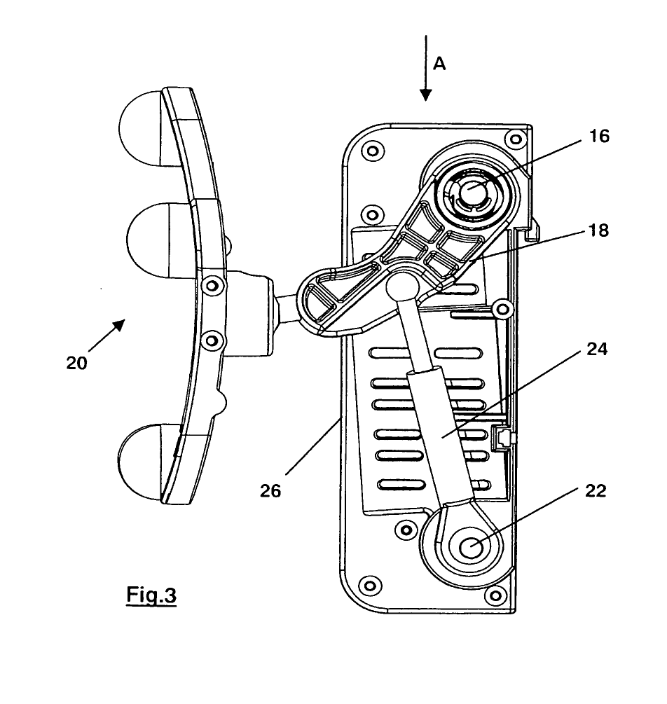

FIG. 3 A side view of a massage carriage,

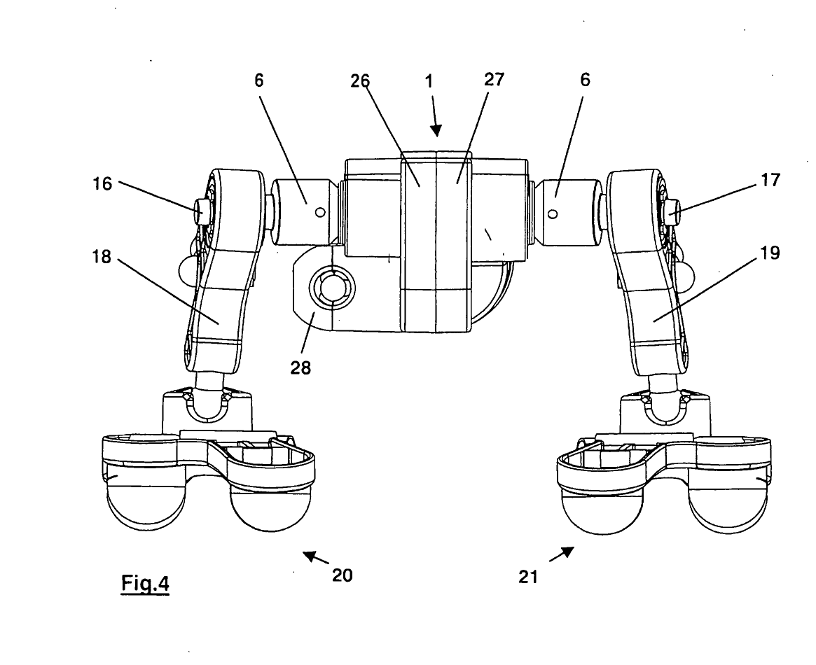

FIG. 4 A top view of the massage carriage, in the direction of arrow A in FIG. 3,

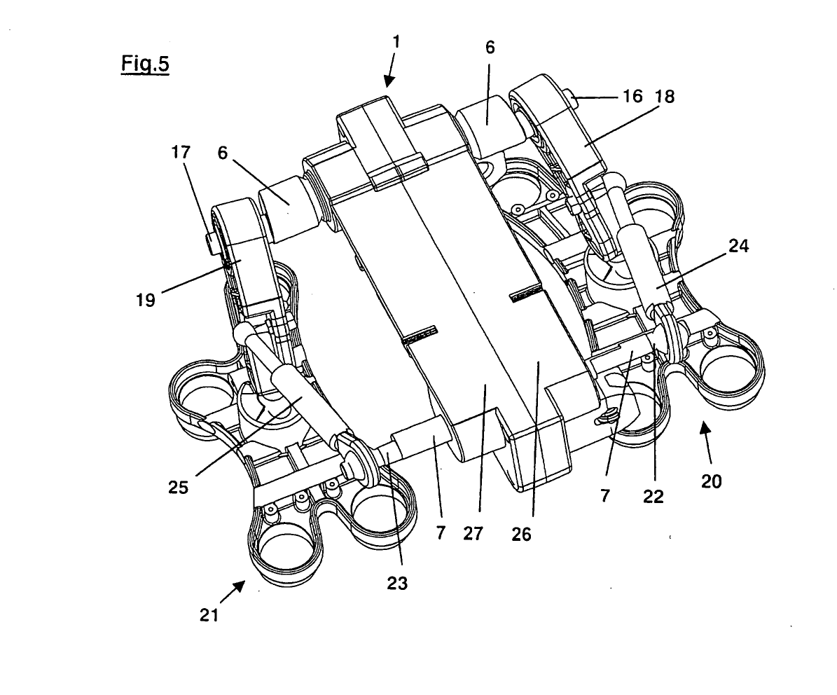

FIG. 5 A rear view of the massage carriage, and

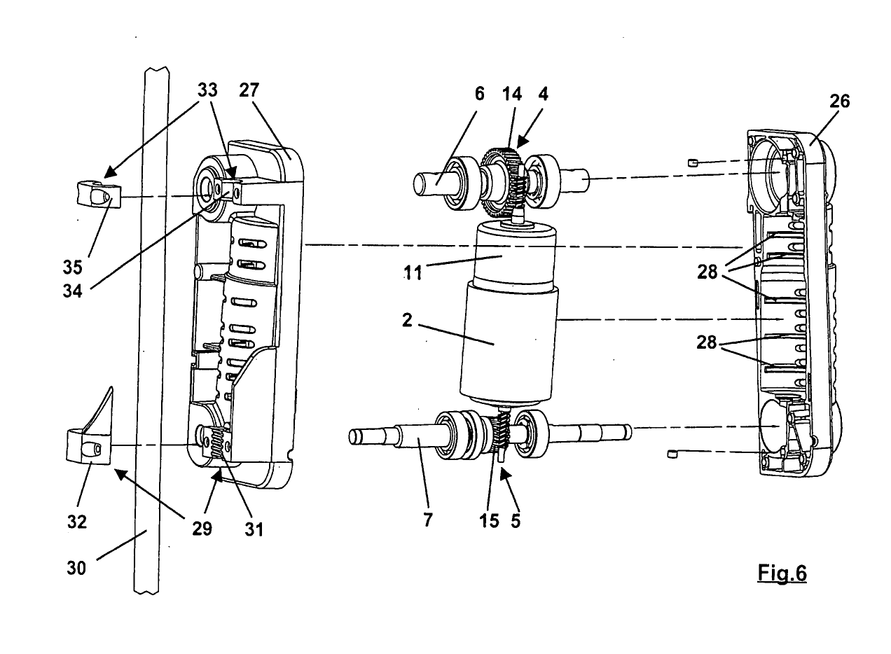

FIG. 6 An exploded representation of the two shells of the drive housing, with the drive unit.

As can be seen from FIGS. 1 and 2, the massage carriage, which can be moved back and forth along a frame, not shown in the Figures, in the backrest of a massage chair or in another item of furniture, comprises a drive 1 with a single motor 2 and a motor shaft 3, by means of which a first and second shaft 6, 7 can be moved via a respective reduction gear 4, 5. Located on opposite face ends of motor 2, motor shaft 3 displays two shaft sections 8 and 9, lying in one axis, by means of which the first and second shafts 6 and 7 can be driven in rotating fashion via the respective reduction gears 4 and 5.

In the practical example illustrated in FIG. 1, shaft sections 8 and 9 form sections of a continuous motor shaft 3.

As can further be seen from FIG. 1, reduction gear 5, via which second shaft 7 can be driven, displays a free-wheel device 10 in a particular sense of rotation of motor shaft 3.

In the more sophisticated practical example illustrated in FIG. 2, shaft section 9 can be permanently driven by motor 2, whereas the other shaft section 8 can be disconnected from motor 2 by means of a clutch 11, which can be designed as an electromagnetic clutch. The clutch displays an automatic brake, not shown in the drawing, which limits or blocks the shaft section on the clutch side via an integrated spring mechanism in disconnected state.

Reduction gear 5, via which second shaft 7 can be driven, displays a free-wheel device 10 in a particular sense of rotation of shaft section 9, which can be permanently driven by the motor.

In the practical examples shown in FIGS. 1 and 2, reduction gears 4 and 5 each consist of a worm gear, with a worm 12 or 13 located on shaft section 8 or 9, respectively, and a worm wheel 14 or 15, interacting with the respective worm.

FIGS. 3 and 4 illustrate a massage carriage with a drive shown in FIG. 1 or 2.

As can particularly be seen from FIGS. 4 and 5, the two ends of first shaft 6, driven by the motor, are provided with eccentric areas 16 and 17, which are angled relative to shaft 6. Two first arms 18 and 19 are mounted freely in terms of the sense of rotation on angled, eccentric areas 16 and 17. The free ends of arms 18 and 19 bear massage elements 20 and 21.

As can furthermore be seen from FIGS. 3 and 5, second shaft 7, driven by the motor, likewise displays eccentric areas 22 and 23 on its two ends, to which two second arms 24 and 25 are connected in articulated fashion. The free ends of second arms 24 and 25 act on the middle area of first arms 18 and 19 via an articulated connection.

By rotating first shaft 6, the two first arms 18 and 19 are, owing to eccentric areas 16 and 17 being angled relative to shaft 6, set into pivoting motion in an essentially vertical plane about a horizontal axis that passes through the intersection of first shaft 6 and the axis of the corresponding eccentric area 16 or 17, angled relative to the shaft (6). This movement of first arms 18, 19 induces the “kneading” movement of massage elements 20 and 21.

Owing to the eccentric arrangement of areas 16 and 17 relative to first shaft 6, and of areas 22 and 23 relative to second shaft 7, driving of first and second shafts 6 and 7 results in generation of an essentially vertical, back-and-forth movement of arms 18 and 19, possibly with an additional, horizontal component, being superimposed on the pivoting movement of first arms 18 and 19. This oscillation of first arms 18 and 19 generates the “tapping” movement of massage elements 20 and 21.

As described in connection with FIGS. 1 and 2, the “kneading” and “tapping” movements can essentially be activated separately by setting the sense of rotation and speed of the motor, or by setting the sense of rotation of the motor and disconnecting or connecting shaft section 8 of motor 2, which drives first shaft 6, in which context the two functions can also be performed simultaneously.

As can particularly be seen from FIG. 6, drive 1 displays a housing, comprising two shells 26 and 27, to accommodate the motor and the gearing parts. The bearing arrangement for the motor and the gearing parts is integrated in the housing in one piece, and comprises webs 28 of appropriate shape for mounting motor 2 and clutch 11, as well as other bearing elements of appropriate design for the gearing parts, which essentially comprise worm wheels 14, 15, mounted on first and second shafts 6, 7, and ball bearings, located on both sides of worm wheels 14, 15.

Shells 26 and 27, webs 28, and the other bearing elements for the gearing parts are made of plastic, injection-molded in one piece.

As illustrated in FIGS. 4 and 6, a nut 29 is located on shell 27 of the drive housing, interacting with a spindle 30, shown in FIG. 6, of a linear drive unit attached to the frame for moving the massage carriage along the frame. One part 31 of nut 29 is integrally molded on shell 27, while the other part 32 can be fastened to part 31 by means of screws in order to accommodate spindle 30 between the two parts.

A further guide element 33 for guiding drive 1 on spindle 30 likewise consists of a part 34, integrally molded on shell 27, and a part 35 that can be fastened to it.

### Massage Carriage

### LIST OF REFERENCE NUMBERS

1 Drive
2 Motor
3 Motor shaft
4 Reduction gear
5 Reduction gear
6 First shaft
7 Second shaft
8 Shaft section
9 Shaft section
10 Free-wheel device
11 Clutch
12 Worm
13 Worm
14 Worm wheel
15 Worm wheel
16 Eccentric area
17 Eccentric area
18 First arm
19 First arm
20 Massage element
21 Massage element
22 Eccentric area
23 Eccentric area
24 Second arm
25 Second arm
26 Shell
27 Shell
28 Web
29 Nut
30 Spindle
31 Part
32 Part
33 Guide element
34 Part
35 Part

1. Massage carriage for use in a massage chair or similar that can be moved back and forth along a frame in the massage chair or similar, comprising a drive (1) that contains at least one motor (2) and gearing parts, a first shaft (6) that can be moved by the drive (1) and a second shaft (7) that can be moved by the drive (1), two first arms (18, 19), which are connected to the first shaft (6), can be moved by the first shaft (6) and on each of which a massage element (20, 21) is mounted, and two second arms (24, 25), which are connected to the second shaft (7) and can be moved by the second shaft (7), one of which each acts on one of the first arms (18, 19), such that the massage elements (20, 21) can be moved by the drive (1) with one movement component oriented parallel to the frame and one oriented perpendicular to the frame, where the drive (1) displays a single motor (2) with a motor shaft (3), characterized in that the motor shaft (3) displays two shaft sections (8, 9), arranged on opposite face ends of the motor (2) and lying on one axis, where the first shaft (6) can be moved by means of the one shaft section (8) via a reduction gear (4), and the second shaft (7) by means of the other shaft section (9) via a reduction gear (5).

2. (canceled)

3. Massage carriage according to claim 1, characterized in that the shaft sections (8, 9) are sections of a continuous motor shaft (3).

4. Massage carriage according to claim 1, characterized in that the reduction gear (5) via which the second shaft (7) can be moved displays a free-wheel device (10) in a particular sense of rotation of the motor shaft.

5. Massage carriage according to claim 1, characterized in that one of the shaft sections (9) can be permanently driven by the motor (2), and the other shaft section (8) can be disconnected from the motor (2) by means of a clutch (11).

6. Massage carriage according to claim 5, characterized in that the clutch (11) is an electromagnetic clutch.

7. Massage carriage according to claim 5, characterized in that the clutch (11) displays an automatic brake, by means of which the disconnectable shaft section (8) can be braked or blocked in disconnected state.

8. Massage carriage according to claim 7, characterized in that the disconnectable shaft section (8) can be braked or blocked by an integrated spring mechanism.

9. Massage carriage according to one of claim 5, characterized in that the reduction gear (5) via which the second shaft (7) can be moved displays a free-wheel device (10) in a particular sense of rotation of the shaft section (9) that can be permanently driven by the motor (2).

10. Massage carriage according to one of claim 1, characterized in that the drive (1) displays a housing comprising two shells (26, 27) for the motor (2) and the gearing parts.

11. Massage carriage according to claim 10, characterized in that the bearing arrangement for the motor (2) and the gearing parts is integrated in the housing in one piece.

12. Massage carriage according to claim 11, characterized in that the housing shells (26, 27) and the bearing arrangement for the motor (2) and the gearing parts are made of plastic, injection-molded in one piece.

13. Massage carriage according to one of claim 10, characterized in that one part (31) of a nut is integrally molded on the housing and interacts with the spindle (30) of a linear drive unit located on the frame for moving the massage carriage along the frame, where the other part (32) of the nut (29) can be fastened to the one part (31) from the outside, such that the spindle (30) can be accommodated between the two parts (31, 32).

14. Massage carriage according to one of claim 1, characterized in that the two reduction gears are designed as worm gears.
